(19) United States
(12) Patent Application Publication
(10) Pub. No.: US 2016/0160839 A1
(43) Pub. Date: Jun. 9, 2016

(54) METHOD FOR CONTROLLING INERTIA RESPONSE OF VARIABLE-SPEED WIND TURBINE GENERATOR

(71) Applicants: State Grid Corporation of China, Beijing (CN); Gansu Electric Power Company of State Grid, Lanzhou (CN)

(72) Inventors: NING-BO WANG, Beijing (CN); KUN DING, Beijing (CN); SHI-YUAN ZHOU, Beijing (CN); JIN LI, Beijing (CN); JIN-PING ZHANG, Beijing (CN); DING-MEI WANG, Beijing (CN); RONG HUANG, Beijing (CN); SHI-EN HE, Beijing (CN)

(21) Appl. No.: 14/564,116

(22) Filed: Dec. 9, 2014

(51) Int. Cl. F03D 7/00; F03D 9/00

(52) U.S. Cl. CPC F03D 7/00; F03D 9/003

(57) ABSTRACT

A method of controlling inertia response of variable-speed wind turbine generator includes following steps. A maximum wind power of the wind turbine is gotten through a wind speed ν_{w} and a rotation speed ωᵣ at the hub of the wind turbine based on a maximum wind power tracking control strategy. The maximum wind power is set as an active power control reference value P₀ of the wind turbine. A grid frequency f is obtained via a frequency measurement equipment. An additional active power control reference value ΔP of the wind turbine is generated based on the grid frequency f via an additional control block, and the additional active power control reference value ΔP is added on the active power control reference value P₀, wherein a total of active power control reference value of the wind turbine is P₀+ΔP.

### BACKGROUND

1. Technical Field

The present disclosure relates to a method of controlling inertia response of variable-speed wind turbine generator.

2. Description of the Related Art

With the rapid development of wind farm industry, the integrated wind power capacity has exceeded 100 giga-watts. The wind power output is dependent on the wind speed. Thus the wind power output has following characteristics: irregular, uncontrollable, volatile, and small credited capacity. The wind power output often brings adverse impact to the operation stability of the power grid.

Power utility companies and agencies need to dispatch wind turbine generators when the grid frequency disturbance occurs via the control device such as power inverter. Thus the wind turbine generators can have a beneficial response to the grid frequency disturbances to maintain the stability of the grid frequency. At present, the inertia response ability of the wind turbine generator has not been fully utilized. The torque, current, and other physical quantities are difficult to be controlled in a reasonable range. The support to the stability of the power system is not optimized enough. Furthermore, the flexibility of the inertia response ability is poor, and the response time is long.

What is needed, therefore, is a method of controlling inertia response of variable-speed wind turbine that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a schematic view of one embodiment of a method of controlling inertia response of variable-speed wind turbine.

FIG. 2 shows a schematic view of one embodiment of a relationship between the mechanical power captured by the wind turbine and the rotation speed of the rotor, and the change of the rotation speed and the mechanical power.

FIG. 3 shows a schematic view of one embodiment of a curve of the electromagnetic power and mechanical power versus time in the method of FIG. 1.

FIG. 4 shows a schematic view of another embodiment of a curve of the electromagnetic power and mechanical power versus time under a setting parameter in the method of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

A method of controlling inertia response of variable-speed wind turbine comprises:

a1, getting a maximum wind power of the wind turbine through a wind speed ν_{w} and a rotation speed ωᵣ at the hub of the wind turbine based on a maximum wind power tracking control strategy;

a2, setting the maximum wind power as an active power control reference value P₀ of the wind turbine;

a3, obtaining a grid frequency f via an frequency measurement equipment; and

a4, generating an additional active power control reference value ΔP of the wind turbine based on the grid frequency f via an additional control block, and adding the additional active power control reference value ΔP on the active power control reference value P₀, and a total of active power control reference value of the wind turbine is P₀+ΔP.

Furthermore, the additional control block adopts a relay style control strategy comprising:

while a changing magnitude Δf of the grid frequency f is greater than a predetermined threshold value, the additional control block is activated;

while the changing magnitude Δf of the grid frequency f is within the range of the predetermined threshold value, the additional control block is not activated.

Furthermore, the predetermined threshold value can be selected according to the frequency fluctuation range under the steady-state operation of the power system.

Furthermore, while the changing magnitude Δf of the grid frequency f is greater than the predetermined threshold value, the additional control block comprises:

a positive control signal ΔP₁ is generated in the additional control block for a length of time t_{dcc}, and the active power or the electromagnetic power temporarily maintains P₀+ΔP₁ based on the active power control reference value P₀ of the wind turbine;

after the inertia response and the transient active power support is activated, a negative control signal ΔP₂ is generated in the additional control block, and the active power or the electromagnetic power temporarily maintains P₀+ΔP₂ which is smaller than the mechanical power captured by the wind turbine; and

during recovery process, the active power output by the wind turbine is depended on P₀+ΔP₂ which is smaller than the active wind power output by the wind turbine at normal operation, and the descent of the grid frequency f is avoided by setting the length of time t_{dcc}.

Furthermore, while the changing magnitude Δf of the grid frequency f is greater than the predetermined threshold value, the positive control signal ΔP₁, the negative control signal ΔP₂, and the length of time t_{dcc} is limited by the a plurality of physical parameters of the wind turbine as follows:

the positive control signal ΔP₁ is selected based on the kinetic energy provided by the wind turbine changing from the current rotation speed to the minimum rotation speed, and it is about 5-10% of the rated power of the wind turbine;

the length of time t_{dcc} is determined by the rotation speed and power of the wind turbine;

the negative control signal ΔP₂ is greater than or equal to down magnitude of the mechanical power of the wind turbine to maintain steady-state operation of the wind turbine;

the sum of the active power control signal ΔP₁ and the negative control signal ΔP₂ does not exceed the predetermined threshold value because of limitation of the torque.

Furthermore, in step a1, the wind speed ν_{w} and wind direction at the hub of the wind turbine is obtained by a wind energy measuring device mounted on the nacelle of the wind turbine.

Furthermore, in step a1, the rotation speed ωᵣ of the wind turbine can be obtained through a speed measurement device mounted on the rotor. In one embodiment, the rotation speed ωᵣ can be estimated by measuring the voltage and the current.

The method of controlling inertia response of variable-speed wind turbine utilizes the maximum wind power tracking control strategy, and the maximum wind power is captured based on the wind speed ν_{w} and the rotation speed ωᵣ measured at the hub of the wind turbine. The maximum wind power is set as the reference value P₀ of the active power control of the wind turbine. The additional control block is added through the grid frequency f based on the maximum wind power tracking control strategy. The short-time constant power support is achieved via look-up table or online tuning method according to the operating condition of the wind turbine, and the inertia response can be emulated. Furthermore, the recovery process of the active power of the wind turbine based on the certain power curve can be achieved. The inertia control of the wind turbine can be achieved utilizing the intrinsic rotational inertia of the rotator of the wind turbine and provide transient active power support to the grid. Thus the inertia response ability of the wind turbine can be fully utilized, and the physical parameter such as torque and current can be controlled in a reasonable range. The support to the frequency stability of the power system can be optimized.

### Embodiment

Wind turbine generator is an electricity generating device capable of converting wind energy into electricity. The wind turbine converts the wind energy into mechanical energy. The mechanical energy is transferred from the wind turbine to the electricity generator. Then the mechanical energy is converted into the electricity which is delivered to the grid.

Variable-speed wind turbine generators are generally equipped with a power electronic converters capable of continuously adjusting the rotation speed of the rotor, thus the wind speed and pitch angle of the wind turbine can be controlled according to different wind speed. Thus the wind turbine generators can be operated in the maximum wind power tracking state or the rated power state, and the wind energy resources can be fully utilized.

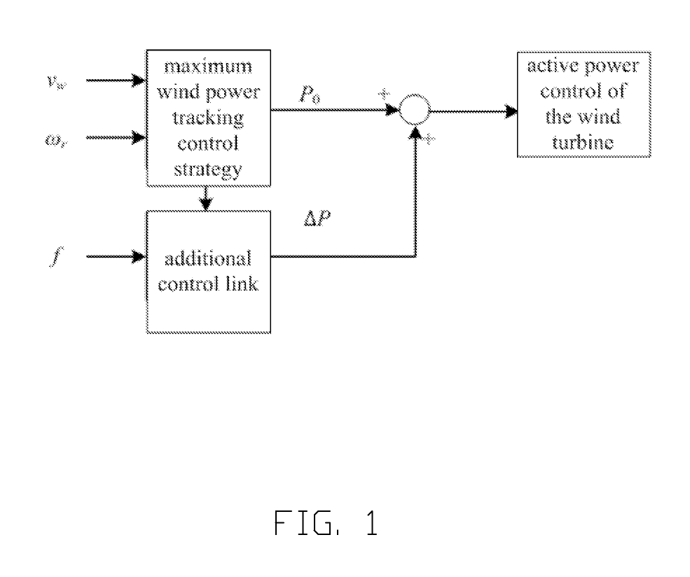

FIG. 1 illustrates the active power control of the wind turbine generators. The wind speed ν_{w} and wind direction can be captured via the wind energy measuring device mounted at the hub of the wind turbine. The rotation speed ωᵣ can be obtained through the rotation speed ωᵣ of the wind turbine can be obtained through the speed measurement device mounted on the rotor. The maximum wind power can be obtained based on the wind speed ν_{w} and rotation speed ωᵣ via the maximum wind power tracking control strategy, and the active power control reference value P₀ of the active power control of the wind turbine can be set according to the maximum wind power.

In order to emulate the inertia response of the wind turbine, the grid frequency f can be obtained through the frequency measurement equipment such as phase-locked loop. The additional active power control reference value ΔP can be generated by the active power additional control of the wind turbine and added to the active power control reference value P₀. Thus the total reference value of the active power control is P₀+ΔP. The additional control block can achieve inertia response emulation via releasing or recovering the kinetic energy of the rotor.

The additional control block adopts the relay style control strategy. While the changing magnitude Δf of the grid frequency f is greater than the predetermined threshold value, the additional control block is activated; while the changing magnitude Δf of the grid frequency f is within the range of the predetermined threshold value, the additional control block will not be activated. The predetermined threshold value can ensure that the control of the inertia response emulation merely responds to the large disturbances to the grid frequency and does not respond to the small disturbance such as frequency stabilization. The predetermined threshold value can be selected according to the fluctuation of the frequency range of the power system to ensure the power system operating in steady state.

While the reduced amplitude of grid frequency exceeds the predetermined threshold value, the additional control block generates the positive control signal ΔP₁ for the length of time t_{dcc}, and ensuring that the active power temporarily maintains P₀+ΔP₁. Thus the inertia response and the transient active power support emulation can be achieved, the rotor will release kinetic energy, the rotation speed is slow down, and the wind turbine deviates from normal operation.

After the inertia response and transient active power support is emulated, the additional control blocks will generate the negative control signal ΔP₂ for the length of time t_{dcc}. Thus the active power temporarily maintains P₀+ΔP₂ which is smaller than the mechanical power captured by the wind turbine. Then the rotation speed of the rotor is increased, and kinetic energy will be increased. Thus the wind turbine is gradually recovered to normal operation state.

During the recovery process, the output active power from the wind turbine generator is depended on P₀+ΔP₂ which is smaller than the output active power while the wind turbine operating at normal state. By setting the appropriate value of time t_{dcc}, the frequency dropping of the grid can be avoided, thus the grid frequency response characteristics can be improved. The active control signal ΔP₁ and the negative control signal ΔP₂ may be a fixed value, or variable.

The control parameters ΔP₁, ΔP₂, and t_{dcc} of the additional control block are limited by the physical parameters of the wind turbine. The rotation speed of the wind turbine need to be controlled between the maximum operating speed and the minimum operating speed. The torque of the wind turbine can be controlled within a certain range to avoid damage to the wind turbine or components caused by the mechanical load.

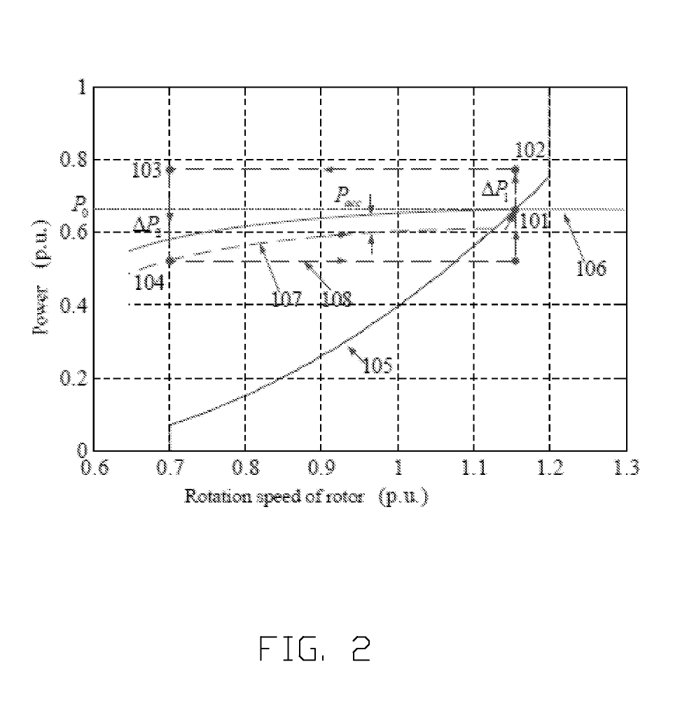

FIG. 2 illustrates the control mechanism of the doubly-fed induction motor. The curve 106 shows the relationship between the mechanical power and the rotation speed under certain wind speed. The rotation speed can be adjusted according to different wind speed to ensure the maximum wind power tracking of the wind speed can be achieved. The relationship between the maximum wind power captured by the wind turbine and the rotation speed under different wind speed is illustrated as curve 105.

The wind turbine is assumed as operating at point 101 before the large disturbance occurred on the grid frequency. The point 101 represents the maximum power on the curve 106 which is captured through controlling the rotation speed of the wind turbine. After the large disturbance occurred, the frequency change exceeds the predetermined threshold value, and the positive control signal ΔP₁ is obtained based on the maximum kinetic energy released by the rotor in the additional control block. The wind turbine operates at point 102 for the value of time t_{dcc}. The rotation speed of the wind turbine is slow down, the mechanical power of the wind turbine is decreased, and the wind turbine operates at point 103.

The positive control signal ΔP₁ is selected according to the kinetic energy provided by the wind turbine while the rotation speed of wind turbine decreases from the current state to the minimum rotation speed. The positive control signal ΔP₁ can be about 5-10% of the rated power of the wind turbine. The length of time t_{dcc} is selected according to the rotation speed and rated power of the wind turbine. The rotation speed of the wind turbine is higher than the minimum rotation speed. Because the mechanical power is decreased, the negative control signal ΔP₂ should be higher than the decreased amplitude of the mechanical power to ensure the operating stability of the wind turbine. Because of the limitation of the torque, the sum of ΔP₁ and ΔP₂ is smaller than the predetermined threshold value.

Referring to FIG. 2, while positive control signal ΔP₁ is changed into the negative control signal ΔP₂ in the additional control block, the wind turbine changes from point 103 to point 104. The negative control signal ΔP₂ can be selected according to need. The wind turbine can recovers from point 104 to point 101 at a constant value along the curve 108. The wind turbine can also recover to point 101 at a constant acceleration power P_{acc} and while the negative control signal ΔP₂ keeps smaller than the mechanical power.

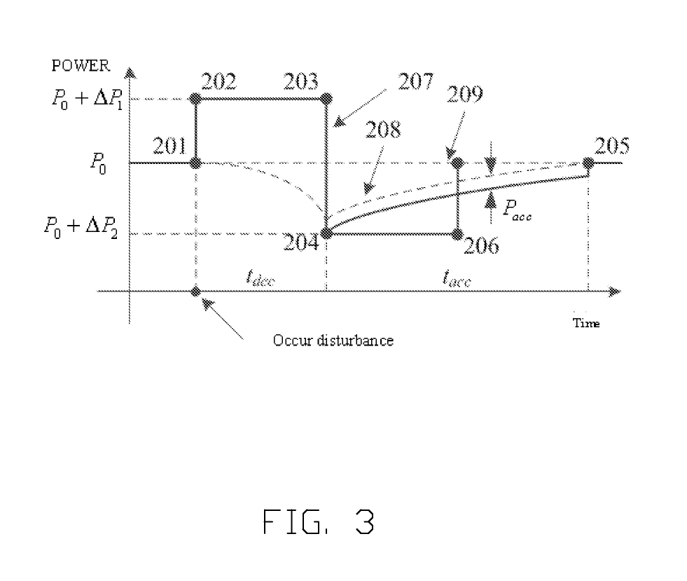

FIG. 3 illustrates the electromagnetic power and mechanical power varies with time in the method of controlling wind turbine inertia response of FIG. 2. Curve 207 represents the active power control reference value of the wind turbine. Curve 208 represents the output mechanical power of the wind turbine. The wind turbine operates at the active power control reference value P₀ before the large disturbance occurred. While the large disturbance occurs, the wind turbine operates from point 201 to point 202. According to the active power reference value P₀+ΔP₁, the wind turbine gradually operates from point 202 to point 203. At the same time, the active control signal ΔP₁ is changed into the negative control signal ΔP₂ in the additional control block, and the wind turbine operates from point 203 to point 204. Then the wind turbine can recover to normal state along the curve from point 204 to point 206 and point 209. The wind turbine can also recover to normal state along the curve from point 204 to point 205 based on the constant acceleration power P_{acc}.

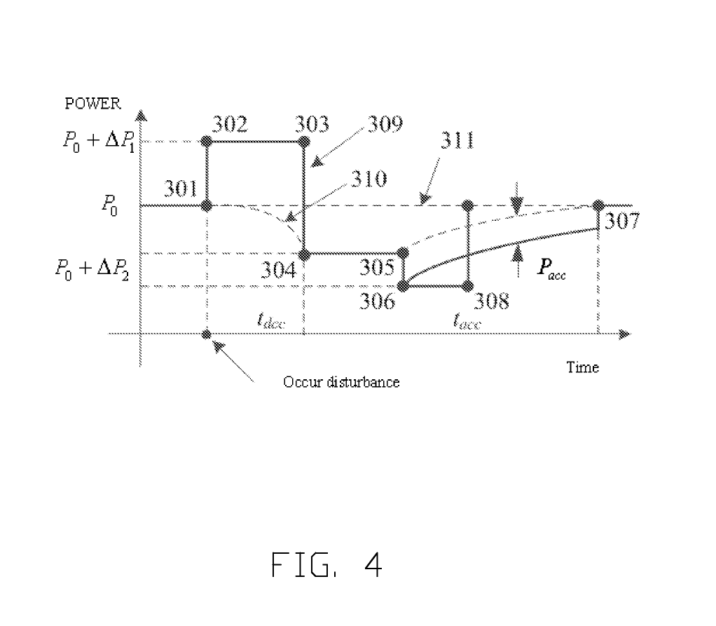

Referring to FIG. 4, while the t_{dcc} can not satisfy the anticipated value due to the limitation of rotation speed and torque under the active control signal ΔP₁, the negative control signal ΔP₂ is selected according to the decrease value of the mechanical power and maintains for the certain length of time, and the beginning process of decrease and recovery of the grid frequency can be effectively avoided. This process is illustrated as the line from point 304 to point 305. Then a larger negative control signal ΔP₂ is selected to make the wind speed recover to normal operation.

The active control signal ΔP₁ is selected according to the need of inertia response such as segment curves, gradient curves, or other parameters. Thus the active control signal ΔP₁ can have a larger value and the wind turbine can response rapidly to the disturbance. The active control signal ΔP₁ can also gradually increase to a certain value to avoid the exceed quantity of the large transient torque.

The control parameters ΔP1, ΔP2, t_{dcc} are determined on the operating conditions and obtained via look-up table or online tuning method. In the online tuning method, the control parameters are determined based on the real-time operation and wind speed of the wind turbine by the control strategy described above. In the look-up table method, the control parameters table corresponding to the wind speed and rotation speed are constructed through the simulation and testing method, and the control parameters can be obtained through the wind speed and rotation speed listed in the table.

The method of controlling inertia response of variable-speed wind turbine has following advantages.

First, the predetermined threshold value is set to ensure that the control of wind turbine inertia response is merely response to the large disturbance to the grid frequency, and will not respond to other small interference such as steady-state frequency modulation.

Second, the determination of the control parameters ΔP1, ΔP2, and t_{dcc} is isolated from the frequency change rate, frequency deviation change rate, frequency deviation amplitude, and frequency deviation integration.

Third, the control parameters ΔP1, ΔP2, and t_{dcc} are depended on the physical parameters of the wind turbine. The wind turbine can release kinetic energy Eₖ=0.5×J×ω₂, which is depended on the moment of inertia J and the rotation speed w.

Fourth, the control parameters ΔP₁, ΔP₂, t_{dcc} are depended on the operation condition of the wind turbine, and can be easily obtained via look-up table or online tuning method.

Fifth, the method can fully take advantage of the moment of inertia of wind turbine, provide inertia response for the disturbance of the grid frequency, and ensure that the parameters of the wind turbine are within the reasonable operating range. Thus the question of the wind speed is too low, the torque is too large, and the current of the rotor is excessive can be avoided.

The method of controlling inertia response of variable-speed wind turbine can effectively reduce the frequency deviation and changing rate after the large disturbance is occurred, and the frequency stability of the power system can be improved.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of controlling inertia response of variable-speed wind turbine generator, the method comprising:
getting a maximum wind power of the wind turbine through a wind speed ν_{w} and a rotation speed ωᵣ at the hub of the wind turbine based on a maximum wind power tracking control strategy;
setting the maximum wind power as an active power control reference value P₀ of the wind turbine;
obtaining a grid frequency f via an frequency measurement equipment; and
generating an additional active power control reference value ΔP of the wind turbine based on the grid frequency f via an additional control block, and adding the additional active power control reference value ΔP on the active power control reference value P₀, wherein a total of active power control reference value of the wind turbine is P₀+ΔP.

2. The method of claim 1, wherein the additional control block adopts a relay style control strategy comprising:
while a changing magnitude Δf of the grid frequency f is greater than a predetermined threshold value, the additional control block is activated;
while the changing magnitude Δf of the grid frequency f is within a range of the predetermined threshold value, the additional control block is not activated.

3. The method of claim 2, wherein the predetermined threshold value is determined by the frequency fluctuation range under the steady-state operation of the power system.

4. The method of claim 2, wherein while the changing magnitude Δf of the grid frequency f is greater than the predetermined threshold value, the additional control block comprises:
a positive control signal ΔP₁ is generated in the additional control block for a length of time t_{dcc}, and the active power temporarily maintains P₀+ΔP₁ based on the active power control reference value P₀ of the wind turbine;
a negative control signal ΔP₂ is generated in the additional control block, and the active power temporarily maintains P₀+ΔP₂ which is smaller than a mechanical power captured by the wind turbine; and
during recovery process, the active power output by the wind turbine is depended on P₀+ΔP₂ and smaller than the active wind power output by the wind turbine at normal operation, and the descent of the grid frequency f is avoided by setting the length of time t_{dcc}.

5. The method of claim 4, wherein while the changing magnitude Δf of the grid frequency f is greater than the predetermined threshold value, the positive control signal ΔP₁, the negative control signal ΔP₂, and the length of time t_{dcc} are limited by the a plurality of physical parameters of the wind turbine as follows:
the positive control signal ΔP₁ is determined based on a kinetic energy provided by the wind turbine changing from the current rotation speed to the minimum rotation speed;
the length of time t_{dcc} is determined by the rotation speed and power of the wind turbine;
the negative control signal ΔP₂ is greater than or equal to decrease magnitude of the mechanical power of the wind turbine; and
a sum of the active power control signal ΔP₁ and the negative control signal ΔP₂ does not exceed the predetermined threshold value.

6. The method of claim 4, wherein the ΔP1, ΔP2, t_{dcc} are obtained via look-up table or online tuning method.

7. The method of claim 6, wherein the ΔP1, ΔP2, t_{dcc} are obtained through a real-time operation and wind speed of the wind turbine.

8. The method of claim 6, wherein a control parameters table corresponding to the wind speed and rotation speed is constructed through simulation and testing method, and ΔP1, ΔP2, t_{dcc} are obtained through the wind speed and rotation speed listed in the control parameters table.

9. The method of claim 1, wherein the wind speed ν_{w} and wind direction at the hub of the wind turbine are obtained by a wind energy measuring device mounted on a nacelle of the wind turbine.

10. The method of claim 1, wherein the rotation speed ωᵣ of the wind turbine is obtained through a speed measurement device mounted on a rotor of the wind turbine.
